(19) United States
(12) Patent Application Publication
(10) Pub. No.: US 2022/0189757 A1
(43) Pub. Date: Jun. 16, 2022

(54) SAMPLE SUPPORT

(71) Applicant: HAMAMATSU PHOTONICS K.K., Hamamatsu-shi, Shizuoka (JP)

(72) Inventors: Masahiro KOTANI, Hamamatsu-shi, Shizuoka (JP); Takayuki OHMURA, Hamamatsu-shi, Shizuoka (JP)

(73) Assignee: HAMAMATSU PHOTONICS K.K., Hamamatsu-shi, Shizuoka (JP)

(21) Appl. No.: 17/442,729

(22) PCT Filed: Jan. 23, 2020
(86) PCT No.: PCT/JP2020/002384

§ 371 Date: Sep. 24, 2021

(30) Foreign Application Priority Data
Mar. 29, 2019 (JP) 2019-066622

(51) Int. Cl. H01J 49/04; H01J 49/16

(52) U.S. Cl. CPC H01J 49/0409; H01J 49/165

(57) ABSTRACT

A sample support body is a sample support body for ionization of a sample, including: a substrate having a first surface, a second surface on a side opposite to the first surface, and a plurality of through-holes opening on each of the first surface and the second surface; and a frame attached to the substrate, in which a thermal conductivity of the frame is 1.0 W/m·K or less.

### TECHNICAL FIELD

The present disclosure relates to a sample support body.

### BACKGROUND ART

As a method of ionizing a sample such as a biological sample for performing mass spectrometry or the like, there are known a matrix-assisted laser desorption/ionization (MALDI) method, a surface-assisted laser desorption/ionization (SALDI) method, a desorption electrospray ionization (DESI) method, and the like. The matrix-assisted laser desorption/ionization method is a method of ionizing a sample by adding an organic compound having a low molecular weight called a matrix that absorbs a laser beam to the sample and irradiating the sample with the laser beam. The surface-assisted laser desorption/ionization method is a method of ionizing a sample by dropping the sample on an ionization substrate having a fine uneven structure on the surface and irradiating the sample with a laser beam. The desorption electrospray ionization method is a method of desorbing and ionizing a sample by irradiating the sample with charged-droplets.

Further, as a sample support body capable of ionizing components of a sample while maintaining position information (two-dimensional distribution information of molecules constituting the sample) of the components of the sample, there is known a sample support body including a substrate having a first surface, a second surface on a side opposite to the first surface, and a plurality of through-holes opening on each of the first surface and the second surface (refer to, for example, Patent Literature 1). In such a sample support body, when the second surface of the substrate is allowed to be in contact with the sample, the components of the sample move from the second surface side to the first surface side via the plurality of through-holes and stay on the first surface side in the substrate.

### CITATION LIST

### Patent Literature

Patent Literature 1: Japanese Patent No. 6093492

### SUMMARY OF INVENTION

### Technical Problem

In the ionization method as described above, a frozen sample is often used as the target. In this case, in the sample support body as described above, it is important how uniformly the components of the sample can be moved via the plurality of through-holes.

An object of the present disclosure is to provide a sample support body capable of uniformly moving components of a sample via a plurality of through-holes, particularly when a frozen sample is used.

### Solution to Problem

A sample support body of one aspect of the present disclosure is a sample support body for ionization of a sample, including: a substrate having a first surface, a second surface on a side opposite to the first surface, and a plurality of through-holes opening on each of the first surface and the second surface; and a frame attached to the substrate, in which a thermal conductivity of the frame is 1.0 W/m·K or less.

In the sample support body, when the second surface of the substrate is allowed to be in contact with the frozen sample and the sample is thawed in that state, the components of the sample move from the second surface side to the first surface side via the plurality of through-holes and stay on the first surface side in the substrate. At this time, since the thermal conductivity of the frame is 1.0 W/m·K or less, for example, even if the frame is handled with bare hands, the heat conduction to the sample via the frame is suppressed, and as a result, the thawing of the sample proceeds uniformly. When the thawing of the sample proceeds uniformly, the sample and the second surface of the substrate are in uniform contact with each other, and as a result, the components of the sample surely move from the second surface side to the first surface side via the plurality of through-holes. Therefore, according to the sample support body, particularly when a frozen sample is used, it is possible to uniformly move the components of the sample via the plurality of through-holes.

In the sample support body of one aspect of the present disclosure, a width of each of the plurality of through-holes may be 1 to 700 nm, and a thickness of the substrate may be 1 to 50 μm. Accordingly, when the second surface of the substrate is allowed to be in contact with the frozen sample and the sample is thawed, the components of the sample can be allowed to smoothly move from the second surface side to the first surface side via the plurality of through-holes in the substrate and to stay on the first surface side in an appropriate state.

In the sample support body of one aspect of the present disclosure, the substrate may be formed by anodizing a valve metal or silicon. Accordingly, it is possible to easily and surely obtain a substrate having a plurality of through-holes.

In the sample support body of one aspect of the present disclosure, respective materials of the substrate and the frame may be electrically insulating materials. Accordingly, for example, in the desorption electrospray ionization method, even if a microdroplet irradiation portion to which a high voltage is applied is allowed to be close to the first surface, the occurrence of electric discharge between the microdroplet irradiation portion and the sample support body is suppressed. Therefore, in the desorption electrospray ionization method, particularly when a frozen sample is used, it is possible to surely ionize the components of the sample by irradiation with charged-droplets.

In the sample support body of one aspect of the present disclosure, a material of the frame may be ceramics or glass. Accordingly, it is possible to easily obtain an electrically insulating frame having a thermal conductivity of 1.0 W/m·K or less. In particular, when the material of the frame is ceramics or glass, it is possible to suppress shrinkage of the sample as thawing of the frozen sample progresses.

In the sample support body of one aspect of the present disclosure, a material of the frame may be a resin. Accordingly, it is possible to easily obtain an electrically insulating frame having a thermal conductivity of 1.0 W/m·K or less. In the sample support body of one aspect of the present disclosure, the resin may be PET, PEN, or PI. Accordingly, it is possible to more easily obtain an electrically insulating frame having a thermal conductivity of 1.0 W/m·K or less.

In the sample support body of one aspect of the present disclosure, a thickness of the frame may be 10 to 500 μm. Accordingly, for example, in the desorption electrospray ionization method, even if the microdroplet irradiation portion is allowed to be close to the first surface, physical interference between the microdroplet irradiation portion and the frame is less likely to occur. Therefore, in the desorption electrospray ionization method, the microdroplet irradiation portion is allowed to be close to the first surface, and the first surface is irradiated with the charged-droplets, so that it is possible to surely ionize the components of the sample that have moved to the first surface side via the plurality of through-holes.

In the sample support body of one aspect of the present disclosure, the frame may have transparency to visible light. Accordingly, the visibility of the sample via the frame is improved, so that it is possible to allow the second surface of the substrate to be reliably in contact with the sample.

In the sample support body of one aspect of the present disclosure, the frame may have flexibility. Accordingly, it is possible to improve the ease of handling the sample support body.

In the sample support body of one aspect of the present disclosure, the substrate is each of a plurality of substrates, the frame is each of a plurality of frames respectively corresponding to the plurality of substrates, and the plurality of frames are connected to each other in a state of being arranged in at least one row. Accordingly, it is possible to separate and use the corresponding substrates and frames as much as necessary.

### Advantageous Effects of Invention

According to the present disclosure, particularly when a frozen sample is used, it is possible to provide a sample support body capable of uniformly moving components of a sample via a plurality of through-holes.

### BRIEF DESCRIPTION OF DRAWINGS

FIG. 1 is a plan view of a sample support body of one embodiment.

FIG. 2 is a cross-sectional view of the sample support body along line II-II illustrated in FIG. 1.

FIG. 3 is a magnified image of a substrate of the sample support body illustrated in FIG. 1.

FIG. 4 is a view illustrating a process of a mass spectrometry method using the sample support body illustrated in FIG. 1.

FIG. 5 is a view illustrating a process of the mass spectrometry method using the sample support body illustrated in FIG. 1.

FIG. 6 is a configuration diagram of a mass spectrometer in which the mass spectrometry method using the sample support body illustrated in FIG. 1 is performed.

FIG. 7 is a perspective view of a sample support body of Modified Example.

FIG. 8 is a view illustrating a process of a mass spectrometry method using the sample support body of Modified Example.

### DESCRIPTION OF EMBODIMENTS

Hereinafter, embodiments of the present disclosure will be described in detail with reference to the drawings. It is noted that that the same or equivalent portions are denoted by the same reference signs in each of the drawings, and duplicate descriptions thereof will be omitted.

[Sample Support Body]

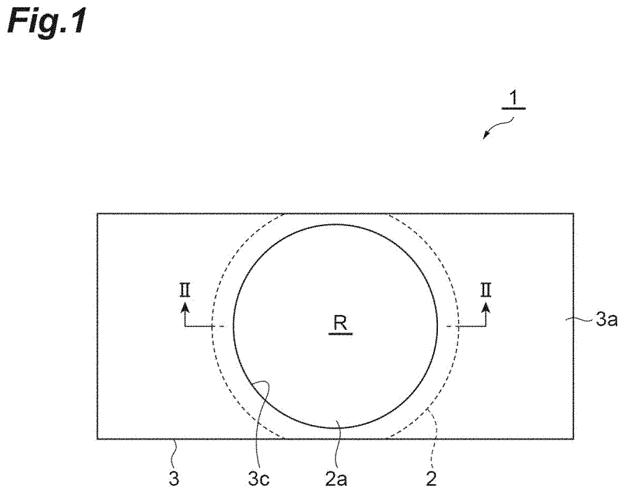

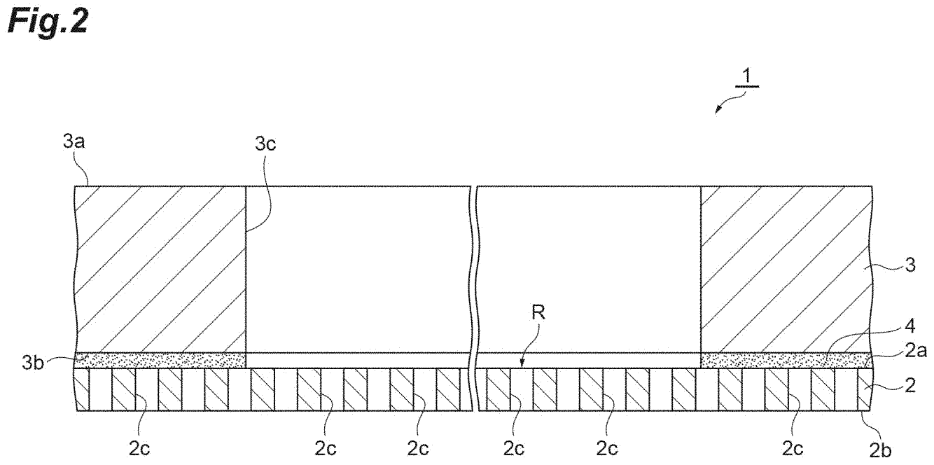

As illustrated in FIGS. 1 and 2, a sample support body 1 includes a substrate 2, a frame 3, and an adhesive layer 4. The substrate 2 has a first surface 2a, a second surface 2b, and a plurality of through-holes 2c. The second surface 2b is a surface on the side opposite to the first surface 2a. Each through-hole 2c opens on each of the first surface 2a and the second surface 2b. In the present embodiment, the plurality of through-holes 2c are formed uniformly (in a uniform distribution) over the entire substrate 2, and each through-hole 2c extends along a thickness direction (direction where the first surface 2a and the second surface 2b face each other) of the substrate 2.

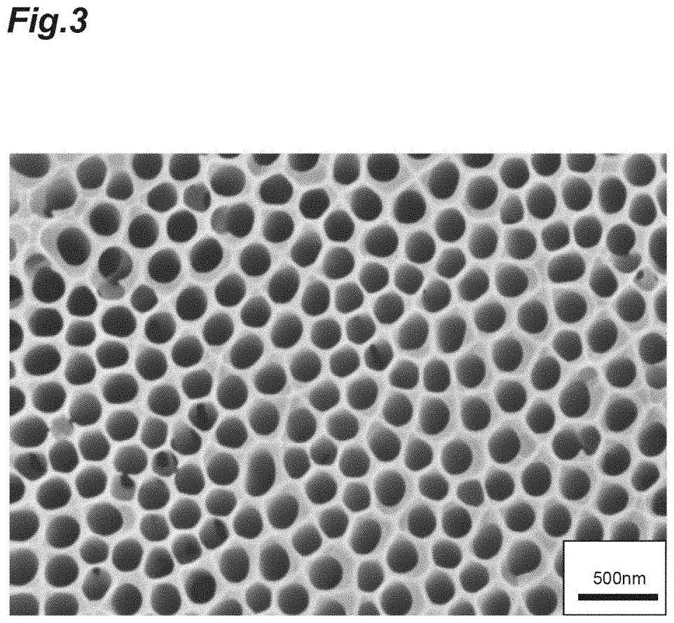

The substrate 2 is an electrically insulating member. In the present embodiment, the thickness of the substrate 2 is 1 to 50 μm, and the width of each through-hole 2c is about 1 to 700 nm. The shape of the substrate 2 when viewed from the thickness direction of the substrate 2 is, for example, a substantially circular shape having a diameter of about several mm to several cm. The shape of each through-hole 2c when viewed from the thickness direction of the substrate 2 is, for example, a substantially circular shape (refer to FIG. 3). It is noted that the width of the through-hole 2c means the diameter of the through-hole 2c when the shape of the through-hole 2c when viewed from the thickness direction of the substrate 2 is a circular shape, and the width of the through-hole 2c means the diameter (effective diameter) of the virtual maximum cylinder that fits in the through-hole 2c when the shape is a shape other than the circular shape.

The frame 3 has a third surface 3a, a fourth surface 3b, and an opening 3c. The fourth surface 3b is a surface on the side opposite to the third surface 3a and is a surface on the substrate 2 side. The opening 3c opens on each of the third surface 3a and the fourth surface 3b. The frame 3 is an electrically insulating member, and the thermal conductivity of the frame 3 is 1.0 W/m·K or less. In the present embodiment, the material of the frame 3 is polyethylene terephthalate (PET), polyethylene naphthalate (PEN) or polyimide (PI), and the thickness of the frame 3 is 10 to 500 μm (more preferably 100 μm or less). Further, in the present embodiment, the frame 3 has transparency to visible light, and the frame 3 has a flexibility. The shape of the frame 3 when viewed from the thickness direction of the substrate 2 is, for example, a rectangle having a side of about several cm. The shape of the opening 3c when viewed from the thickness direction of the substrate 2 is, for example, a circular shape having a diameter of about several mm to several cm. It is noted that the lower limit of the thermal conductivity of the frame 3 is, for example, 0.1 W/m·K.

The frame 3 is attached to the substrate 2. In the present embodiment, the region of the first surface 2a of the substrate 2 along an outer edge of the substrate 2 and the region of the fourth surface 3b of the frame 3 along an outer edge of the opening 3c are fixed to each other by the adhesive layer 4. The material of the adhesive layer 4 is, for example, an adhesive material (low melting point glass, vacuum adhesive, or the like) having little discharge gas. In the sample support body 1, the portion of the substrate 2 corresponding to the opening 3c of the frame 3 functions as an effective region R for moving the components of the sample from the second surface 2b side to the first surface 2a side via the plurality of through-holes 2c.

FIG. 3 is an enlarged image of the substrate 2 when viewed from the thickness direction of the substrate 2. In FIG. 3, the black portion is the through-hole 2c, and the white portion is a partition wall portion between the through-holes 2c. As illustrated in FIG. 3, the plurality of through-holes 2c having a substantially constant width are uniformly formed on the substrate 2. The aperture ratio (the ratio of all the through-holes 2c to the effective region R when viewed from the thickness direction of the substrate 2) of the through-holes 2c in the effective region R is practically 10 to 80%, in particular, is preferably 60 to 80%. The sizes of the plurality of through-holes 2c may be irregular to each other, or the plurality of through-holes 2c may be partially connected to each other.

The substrate 2 illustrated in FIG. 3 is an alumina porous film formed by anodizing aluminum (Al). Specifically, the substrate 2 can be obtained by performing anodizing treatment on the Al substrate and peeling the oxidized surface portion from the Al substrate. It is noted that the substrate 2 may be formed by anodizing a valve metal other than Al such as tantalum (Ta), niobium (Nb), titanium (Ti), hafnium (Hf), zirconium (Zr), zinc (Zn), tungsten (W), bismuth (Bi), or antimony (Sb) or may be formed by anodizing silicon (Si).

[Ionization Method and Mass Spectrometry Method]

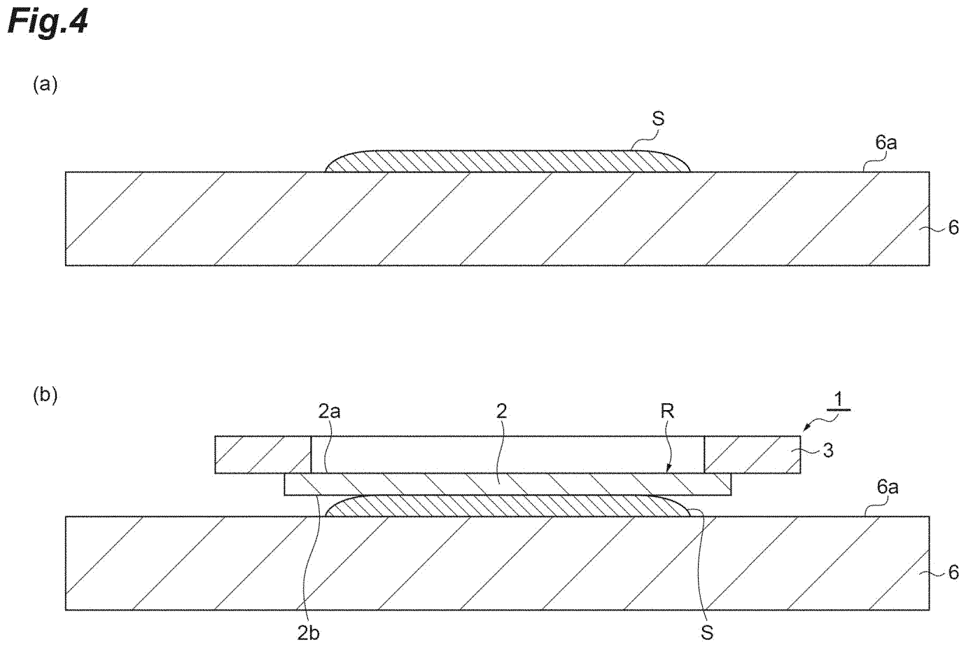

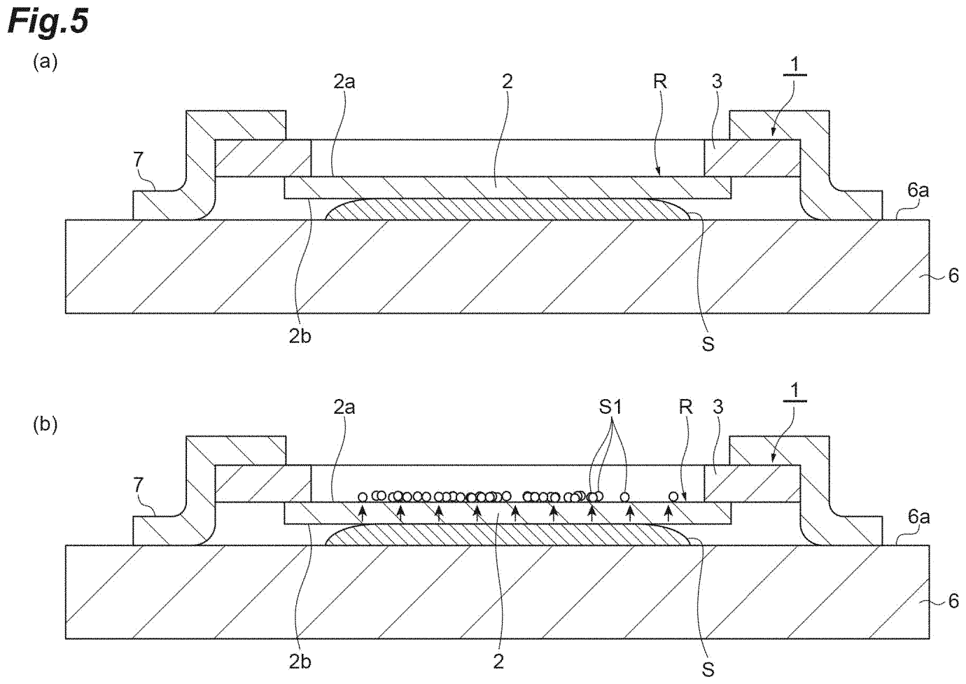

The ionization method and the mass spectrometry method using the sample support body 1 will be described. The ionization method herein is a desorption electrospray ionization method. Since the desorption electrospray ionization method is performed in an atmospheric pressure ambience, it is possible to directly analyze the sample, and thus, the desorption electrospray ionization method is advantageous in that the sample can be easily exchanged for the observation and the analysis. It is noted that, in FIGS. 4 and 5, in the sample support body 1, the through-hole 2c and the adhesive layer 4 are omitted in illustration. Further, the sample support body 1 illustrated in FIGS. 1 and 2 and the sample support body 1 illustrated in FIGS. 4 and 5 have different dimensional ratios and the like for the convenience of illustration.

First, the above-described sample support body 1 is prepared as the sample support body for ionizing the sample (first process). The sample support body 1 may be prepared by being manufactured by a practitioner of the ionization method and the mass spectrometry method, or may be prepared by being transferred from a manufacturer, a seller, or the like of the sample support body 1.

Subsequently, as illustrated in (a) of FIG. 4, a sample S is mounted on a mount surface 6a of a slide glass (mount portion) 6 (second process). The sample S is a biological sample (water-containing sample) in a thin-film state such as a tissue section and is in a frozen state. Subsequently, as illustrated in (b) of FIG. 4, the sample support body 1 is mounted on the mount surface 6a so that the second surface 2b of the substrate 2 is in contact with the sample S (second process). At this time, the sample support body 1 is arranged so that the sample S is located in the effective region R when viewed from the thickness direction of the substrate 2. Subsequently, as illustrated in (a) of FIG. 5, the frame 3 is fixed to the slide glass 6 by using an electrically insulating tape 7. When the sample S is thawed in this state, as illustrated in (b) of FIG. 5, in the substrate 2, components S1 of the sample S move from the second surface 2b side to the first surface 2a side via the plurality of through-holes 2c (refer to FIG. 2) due to, for example, a capillary phenomenon, and the components S1 of the sample S stay on the first surface 2a side due to, for example, surface tension.

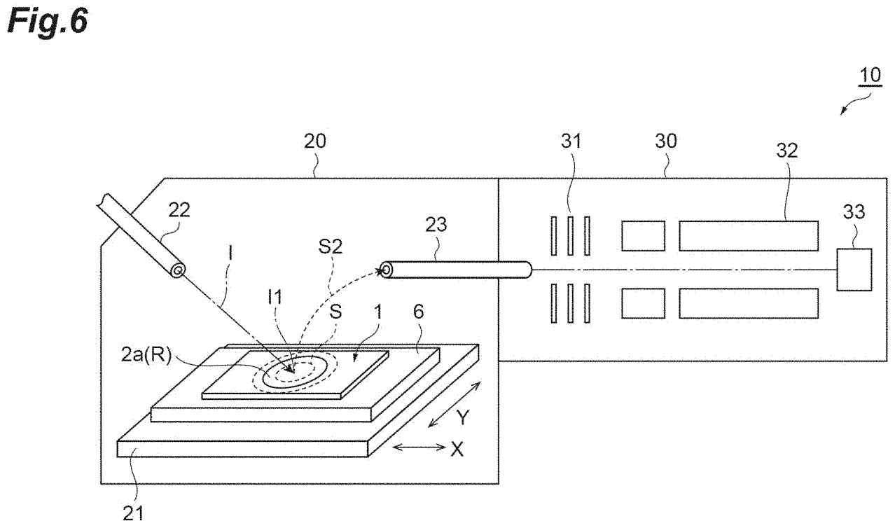

Subsequently, when the sample S is dried, as illustrated in FIG. 6, the slide glass 6, the sample S, and the sample support body 1 are mounted on a stage 21 in an ionization chamber 20 of a mass spectrometer 10. The inside of the ionization chamber 20 has an atmospheric pressure ambience. Subsequently, the region of the first surface 2a of the substrate 2 corresponding to the effective region R is irradiated with charged-droplets I to ionize the components S1 of the sample S that have moved to the first surface 2a side, and the sample ions S2 which are ionized components are sucked (third process). In the present embodiment, for example, by moving the stage 21 in an X-axis direction and a Y-axis direction, an irradiation region I1 of the charged-droplets I is moved relative to the region of the first surface 2a of the substrate 2 corresponding to the effective region R (that is, the region is scanned with the charged-droplets I). The above first process, second process and third process correspond to the desorption electrospray ionization method using the sample support body 1.

In the ionization chamber 20, the charged-droplets I are sprayed from a nozzle 22, and the sample ions S2 are sucked from the suction port of an ion transport tube 23. The nozzle 22 has a double cylinder structure. A solvent is guided to the inner cylinder of the nozzle 22 in a state where a high voltage is applied. Accordingly, biased charges are applied to the solvent that has reached the tip of the nozzle 22. Nebrize gas is guided to the outer cylinder of the nozzle 22. Accordingly, the solvent is sprayed as microdroplets, and the solvent ions generated in the process of vaporizing the solvent are emitted as the charged-droplets I.

The sample ions S2 sucked from the suction port of the ion transport tube 23 are transported into a mass spectrometry chamber 30 by the ion transport tube 23. The inside of the mass spectrometry chamber 30 is under a high vacuum ambience (ambience having a vacuum degree of 10⁻⁴ Torr or less). In the mass spectrometry chamber 30, the sample ions S2 are converged by an ion optical system 31 and introduced into a quadrupole mass filter 32 to which a high frequency voltage is applied. When the sample ions S2 are introduced into the quadrupole mass filter 32 to which the high frequency voltage is applied, ions having a mass number determined by the frequency of the high frequency voltage are selectively passed, and the passed ions are detected by a detector 33 (fourth process). By scanning with the frequency of the high frequency voltage applied to the quadrupole mass filter 32, the mass number of the ions reaching the detector 33 is sequentially changed to obtain mass spectra in a predetermined mass range. In the present embodiment, the detector 33 detects ions so as to correspond to the position of the irradiation region I1 of the charged-droplets I to form an image from the two-dimensional distribution of the molecules constituting the sample S. The above first process, second process, third process and fourth process correspond to the mass spectrometry method using the sample support body 1.

[Function and Effect]

In the sample support body 1, when the second surface 2b of the substrate 2 is allowed to be in contact with the frozen sample S and the sample S is thawed in that state, the components S1 of the sample S move from the second surface 2b side to the first surface 2a side via the plurality of through-hole 2c and stay on the first surface 2a side in the substrate 2. At this time, since the thermal conductivity of the frame 3 is 1.0 W/m·K or less, for example, even if the frame 3 is handled with bare hands, the heat conduction to the sample S via the frame 3 is suppressed, and as a result, the thawing of the sample S proceeds uniformly. When the thawing of the sample S proceeds uniformly, the sample S and the second surface 2b of the substrate 2 are in uniform contact with each other, and as a result, the components S1 of the sample S surely move from the second surface 2b side to the first surface 2a side via the plurality of through-holes 2c. Therefore, according to the sample support body 1, particularly when the frozen sample S is used, it is possible to uniformly move the components S1 of the sample S via the plurality of through-holes 2c.

Further, in the sample support body 1, the width of each through-hole 2c is 1 to 700 nm, and the thickness of the substrate 2 is 1 to 50 μm. Accordingly, when the second surface 2b of the substrate 2 is allowed to be in contact with the frozen sample S and the sample S is thawed in that state, the components S1 of the sample S are allowed to smoothly move from the second surface 2b side to the first surface 2a side via the plurality of through-holes 2c in the substrate 2 and to stay on the first surface 2a side in an appropriate state.

Further, in the sample support body 1, the substrate 2 is formed by anodizing the valve metal or silicon. Accordingly, it is possible to easily and surely obtain the substrate 2 having the plurality of through-holes 2c.

Further, in the sample support body 1, respective materials of the substrate 2 and the frame 3 are electrically insulating materials. Accordingly, for example, in the desorption electrospray ionization method, even if the nozzle 22 that is a microdroplet irradiation portion to which a high voltage is applied is allowed to be close to the first surface 2a, the occurrence of electric discharge between the nozzle 22 and the sample support body 1 is suppressed. When the distance between the nozzle 22 and the sample support body 1 is shortened, the diffusion of the electrospray (spray of the charged-droplets) is suppressed in imaging, so that it is possible to improve spatial resolution. For this reason, allowing the nozzle 22 to be closer to the first surface 2a as described above is extremely effective in surely ionizing the components S1 of the sample S. Therefore, in the desorption electrospray ionization method, particularly when the frozen sample S is used, the components S1 of the sample S can be surely ionized by irradiation with the charged-droplets I.

Further, in the sample support body 1, the material of the frame 3 is PET, PEN, or PI. Accordingly, it is possible to easily obtain the electrically insulating frame 3 having a thermal conductivity of 1.0 W/m·K or less.

Further, in the sample support body 1, the thickness of the frame 3 is 10 to 500 μm (more preferably 100 μm or less). Accordingly, for example, in the desorption electrospray ionization method, even if the nozzle 22 is allowed to be close to the first surface 2a, physical interference between the nozzle 22 and the frame 3 is less likely to occur. Therefore, in the desorption electrospray ionization method, the nozzle 22 is allowed to be close to the first surface 2a, and the first surface 2a is irradiated with the charged-droplets I, so that it is possible to surely ionize the components S1 of the sample S that have moved to the first surface 2a side via the plurality of through-holes 2c.

Further, in the sample support body 1, the frame 3 has transparency to visible light. Accordingly, the visibility of the sample S via the frame 3 is improved, so that it is possible to allow the second surface 2b of the substrate 2 to be reliably in contact with the sample S.

Further, in the sample support body 1, the frame 3 has a flexibility. Accordingly, it is possible to improve the ease of handling of the sample support body 1.

### Modified Example

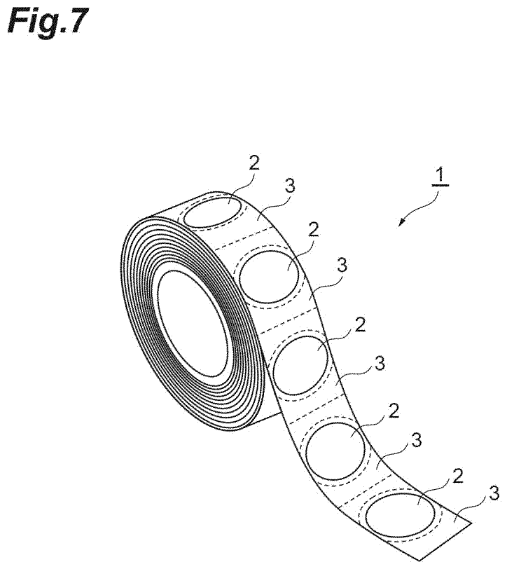

The present disclosure is not limited to the embodiments described above. For example, as illustrated in FIG. 7, the sample support body 1 may include a plurality of substrates 2 and a plurality of frames 3 corresponding to the plurality of substrates 2, respectively, and the plurality of frames 3 may be connected to each other in the state of being arranged in at least one row. Accordingly, the corresponding substrate 2 and frame 3 can be separated and used as much as necessary. It is noted that, in this case, if the frame 3 has a flexibility, the sample support body 1 can be handled in a state where the plurality of frames 3 connected to each other are wound up in a roll shape in a state of being arranged in at least one row.

Further, the material of the frame 3 may be a resin other than PET, PEN, or PI. Even in this case, it is possible to easily obtain the electrically insulating frame 3 having a thermal conductivity of 1.0 W/m·K or less. Further, the material of the frame 3 may be ceramics or glass. Even in this case, it is possible to easily obtain the electrically insulating frame 3 having a thermal conductivity of 1.0 W/m·K or less. In particular, when the material of the frame 3 is ceramics or glass, it is possible to suppress shrinkage of the sample S as the thawing of the frozen sample S proceeds. It is noted that the material of the frame 3 is not particularly limited as long as the frame 3 having a thermal conductivity of 0.1 W/m·K can be implemented. Further, the frame 3 may be colored with, for example, a pigment. Accordingly, it is possible to classify the sample support body 1 according to the application.

Further, in the above-described embodiment, one effective region R is provided on the substrate 2, but a plurality of the effective regions R may be provided on the substrate 2. Further, in the above-described embodiment, the plurality of through-holes 2c are formed in the entire substrate 2, but the plurality of through-holes 2c may be formed in a portion of the substrate 2 corresponding to at least the effective region R. Further, in the above-described embodiment, the sample S is arranged so that one sample S corresponds to one effective region R, but the sample S may be arranged so that a plurality of the samples S correspond to one effective region R.

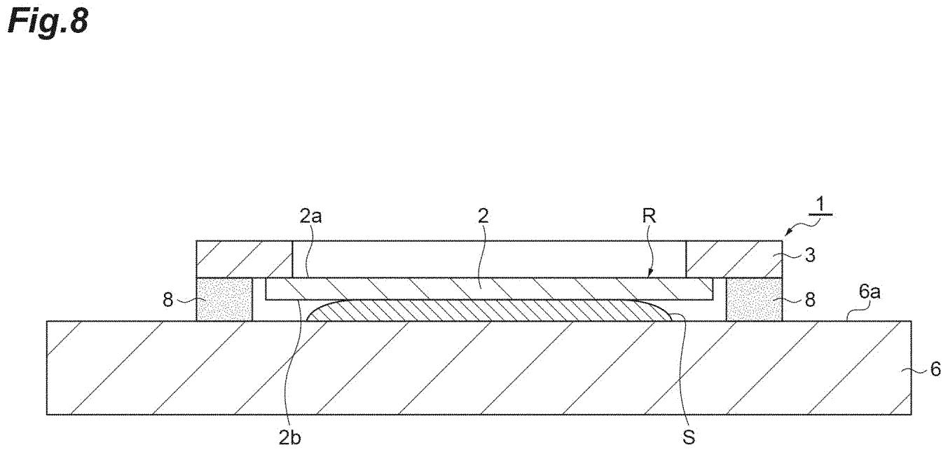

Further, an opening different from the opening 3c may be formed in the frame 3, and the sample support body 1 may be fixed to the slide glass 6 with the tape 7 by using the opening. Further, the sample support body 1 may be fixed to the slide glass 6 by means (for example, means using an adhesive, a fixture, or the like) other than the tape 7. As an example, as illustrated in FIG. 8, the sample support body 1 may be fixed to the slide glass 6 using a gel 8. In this case, it is preferable that the gel 8 is a material (for example, glycerol or the like) that does not harden in a low temperature environment for handling the frozen sample S. As a procedure, the gel 8 is applied to a region (for example, four corners or the like of the frame 3) of the frame 3 on the surface of the substrate 2 side where the substrate 2 is not fixed. At this time, the gel 8 is applied to the region so that the gel 8 does not protrude into the effective region R of the substrate 2. Subsequently, the sample support body 1 is mounted on the mount surface 6a of the slide glass 6 while allowing the effective region R of the substrate 2 to be in contact with the sample S. It is noted that, when the material of the frame 3 is a resin, it is also possible to fix the sample support body 1 to the slide glass 6 by using static electricity.

Further, the sample S is not limited to the water-containing sample and may be a dry sample. When the sample S is a dry sample, a solution (for example, an acetonitrile mixture) for lowering a viscosity of the sample S is added to the sample S. Accordingly, it is possible to allow the components S1 of the sample S to move to the first surface 2a side of the substrate 2 via the plurality of through-holes 2c, for example, by the capillary phenomenon.

Further, the sample support body 1 may be used for an ionization method other than the desorption electrospray ionization method. In other ionization methods, in some cases, the frame 3 may have a conductivity. Further, in other ionization methods, the substrate 2 itself may have a conductivity, or a conductive film may be formed in the substrate 2. It is noted that the material of the conductive film is preferably a metal having a low affinity with a sample (for example, a protein or the like), and for example, gold (Au), platinum (Pt), chromium (Cr), nickel (Ni), titanium (Ti), or like is preferable.

Various materials and shapes can be applied to each configuration in the above-described embodiment without being limited to the above-described materials and shapes. In addition, each configuration in one embodiment or Modified Example described above can be arbitrarily applied to each configuration in another embodiment or Modified Example.

### REFERENCE SIGNS LIST

1: sample support body, 2: substrate, 2a: first surface, 2b: second surface, 2c: through-hole, 3: frame.

1. A sample support body for ionization of a sample, comprising:
a substrate having a first surface, a second surface on a side opposite to the first surface, and a plurality of through-holes opening on each of the first surface and the second surface; and
a frame attached to the substrate,
wherein a thermal conductivity of the frame is 1.0 W/m·K or less.

2. The sample support body according to claim 1,
wherein a width of each of the plurality of through-holes is 1 to 700 nm, and
wherein a thickness of the substrate is 1 to 50 μm.

3. The sample support body according to claim 1, wherein the substrate is formed by anodizing a valve metal or silicon.

4. The sample support body according to claim 1, wherein respective materials of the substrate and the frame are electrically insulating materials.

5. The sample support body according to claim 4, wherein a material of the frame is ceramics or glass.

6. The sample support body according to claim 4, wherein a material of the frame is a resin.

7. The sample support body according to claim 6, wherein the resin is PET, PEN, or PI.

8. The sample support body according to claim 1, wherein a thickness of the frame is 10 to 500 μm.

9. The sample support body according to claim 1, wherein the frame has transparency to visible light.

10. The sample support body according to claim 1, wherein the frame has a flexibility.

11. The sample support body according to claim 1,
wherein the substrate is each of a plurality of substrates,
wherein the frame is each of a plurality of frames respectively corresponding to the plurality of substrates, and
wherein the plurality of frames are connected to each other in a state of being arranged in at least one row.
